(19) United States
(12) Patent Application Publication
(10) Pub. No.: US 2005/0147836 A1
(43) Pub. Date: Jul. 7, 2005

(54) Composite materials for sensing applications and chemical sensor comprising said materials

(76) Inventors: Luciana Sartore, Brescia (IT); Maurizio Penco, Brescia (IT); Fabio Bignotti, Brescia (IT); Giorgio Sberveglieri, Brescia (IT)

Correspondence Address: SUGHRUE MION, PLLC, 2100 PENNSYLVANIA AVENUE, N.W., SUITE 800, WASHINGTON, DC, 20037, US

(21) Appl. No.: 10/508,215

(22) PCT Filed: Mar. 18, 2003
(86) PCT No.: PCT/IB03/01056

(30) Foreign Application Priority Data
Mar. 19, 2002 (IT) TO2002A000244

(51) Int. Cl. G01N 27/26; B32B 27/08

(52) U.S. Cl. 428/474.4; 204/415

(57) ABSTRACT

A chemical sensor for detecting an analyte in a fluid, useful for the production of an apparatus for the analysis of odours (an electronic nose), comprises a film of composite material formed by a matrix of a non-conductive polymer constituted by a polyamidoamine and a conductive filler, e.g. carbon black. In preferred embodiments, the polyamidoamine is formed as the adduct of bisacrylamidoacetic (BAC) and N, N′-dimethylethylenediamide (DMEDA) else N, N′-ethlenediaminoaceticacid (EDDA), and can include copper or cobalt ions as complexes.

The present invention relates in general to chemical sensors for detecting an analyte in a fluid and provides novel composite materials useful for such applications.

The increasing need to analyze odours has led, up to now, to the development of devices known as electronic noses, which are constituted by a series of partially selective chemical sensors that can recognize simple and complex odours.

These devices can be used in the “gas sensing” field to detect individual gases/vapours or mixtures thereof.

In order to produce sensors, considerable efforts have been dedicated to the development of inorganic materials, of which semiconductor oxides are a representative class. These have permitted the production of sensors with good sensitivity to fuel gases but with the considerable disadvantage of high working temperatures.

An interesting alternative is represented by organic materials.

In this case, most sensitive units detect the change of a physical or chemical property of a polymer film due to exposure to a gaseous analyte.

There are many quantities which can be measured; for example, the shift in the resonance frequency of a quartz crystal, or changes in surface configuration by means of sound waves or changes in electrical resistance in intrinsically conductive polymers or in composites constituted by a polymer and a dispersed conductive phase, generally composed of carbon black.

Sensors of this type, to which the present invention relates, are described in patents U.S. Pat. No. 5,571,401, U.S. Pat. No. 5,788,883, U.S. Pat. No. 5,911,872, U.S. Pat. No. 6,093,308, U.S. Pat. No. 6,331,240, and in the publication M. C. Lonergan et al., in Chem. Mat. (1996), 2298-2312, the descriptions of which should be referred to with regard to the general operating principles and constructional characteristics of the sensors.

In particular, the sensors described in the above-mentioned documents comprise a first conductive terminal and a second conductive terminal which are connected electrically to and separated by a chemically sensitive element constituted by a film of composite material, generally deposited on an insulating substrate such as alumina, glass, or ceramic material.

As is described, for example, in U.S. Pat. No. 5,571,401, the resistive elements are produced by the mixing of a conductive material with a non-conductive organic polymer so that the electrically conductive path between the conductive terminals connected to the resistor is interrupted by gaps of non-conductive organic polymer.

For example, in a colloid, suspension or dispersion of particulate conductive material in a matrix of conductive organic polymer material, the regions of the matrix which separate the particles provide the gaps. The non-conductive gaps have a path length of about 10 to 1000 Angstrom, usually of the order of 100 Angstrom, providing individual resistances of about 10 to 1000 mΩ across each gap.

Organic conductors such as, in particular, conductive polymers (polypyrroles) and carbon materials, in particular carbon black, graphite and coke, as well as inorganic conductors such as metals and metal alloys are proposed as conductive materials.

The non-conductive polymers may be selected from a wide range including polyolefins, polydienes, polyacrylates, polymethacrylates, vinyl polymers, polycarbonates, polyesters, polyamines, polyurethanes, polysilanes, and various polymers derived from heterocyclic monomers.

The sensor thus obtained has a characteristic resistance in the absence of gas of any composition. When the sensor is exposed to an atmosphere containing organic vapours, it absorbs or adsorbs them, undergoing swelling which brings about a corresponding increase in the resistivity of the sensor due to the partial interruption of the contacts in the dispersed conductive phase.

A plurality of these sensors, connected in a matrix configuration, can be used to detect an analyte in a fluid, in combination with an electrical measuring apparatus, to form a gas analyzing device (an electronic nose).

The main limitations relating to the known sensors of the type described above, however, lie in their sensitivity limits when the gas to be detected is in concentrations below one part per thousand, and in their low selectivity with respect to different gas concentrations.

There is therefore still a need to provide novel composite materials for use in sensors of the above-mentioned type.

In particular, an object of the present invention is to provide a sensor which is extremely selective with respect to the different chemical compositions of the gases with which it is placed in contact.

A further object is to provide a sensor which identifies gas concentrations of the order of parts per million.

These objects are achieved by means of composite materials in the form of films and of sensors comprising these materials, as defined in the appended claims.

The sensors according to the invention are intended to be connectible in a matrix configuration within a gas analyzing device (an electronic nose) which constitutes a further subject of the invention.

In particular, the sensor according to the invention has a high selectivity for the gases to which it is exposed, in particular to amines, and a high efficiency since it absorbs and desorbs rapidly at ambient temperature and has a considerable resistance to continuous and repeated absorption and desorption cycles.

According to the invention, the film of composite material—usable as a sensor element—comprises a conductive filler, a multifunctional polymer constituted by a polyamidoamine (PAA) and, optionally, a surfactant, preferably a non-ionic surfactant, and also optionally a plasticizer for the polymer.

The same fillers as are described in U.S. Pat. No. 5,571,401 (see in particular, col. 4, lines 20-35), may be used as conductive fillers but carbon black and metal powders are preferred.

PAAs are a class of regular amine polymers which can be produced with a considerable variety of structures by poly-addition reaction of primary monoamines or secondary bisamines with bisacrylamides.

These polymers are soluble in water and non-toxic and, by virtue of their capacity to form stable complexes with well-defined stoichiometry with heavy metal ions (M. Casolaro, F. Bignotti, L. Sartore, M. Penco, P. Ferruti, Current Trends in Polymer Science, Vol. 3, 173-182 (1998); M. Casolaro, F. Bignotti, L. Sartore, M. Penco, Polymer, 42, 903-912 (2001)), their use as material for the removal of heavy metals from water has been proposed (L. Sartore et al., Italian patent MI98A002710).

The polymerization reaction generally takes place in water or alcohols at ambient temperature and without the use of catalysts. In particular, the following structures can be obtained: 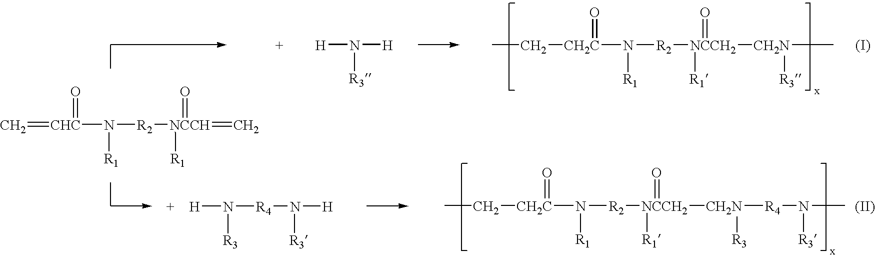
where R₁ and R₁′, independently of one another, may be a hydrogen or a linear or branched CₙH₂ₙ₊₁ hydrocarbon chain where n=1-4,
R₂ may be CH—COOH or a linear or branched CₙH₂ₙ hydrocarbon chain where n=1-4,
R₃, R₃′ and R₃″, independently of one another, may be CH₂—COOH, CH₂—CH₂—OH, CH₂—CH₂—N(CH₃)₂ or a linear or branched CₙH₂ₙ₊₁ hydrocarbon chain where n=1-4,
R₄ may be a linear or branched CₙH₂ₙ hydrocarbon chain where n=2-4, and
X is a whole number between 1 and 100.

The PAAs that are used preferably have the structure of formula II given above, in which the substituents have the meanings given above.

More preferably both R₁ and R₁′ are hydrogen, R₂ is CH—COOH, R₃, R₃′, and R₃″ are selected between CH₃ and CH₂COOH, and X is between 10 and 60.

The conductive film is typically prepared by dissolving the polymer material in water and adding the conductive filler (carbon black, metal powders, etc.). A surfactant, preferably a non-ionic surfactant, for example, Brij 30, may be added to the suspension thus obtained.

Finally, the suspension is deposited on a substrate and the solvent is allowed to evaporate.

The conductive filler is preferably constituted by carbon black.

Alternatively, the conductive film may be prepared by dissolving the polymer material in water and adding metal ions and the conductive filler (carbon black, metal powders, etc.). A surfactant, for example Brij 30, is optionally added to the suspension thus obtained. Finally, the suspension is deposited on a substrate and the solvent is allowed to evaporate.

The ions are generally heavy metal ions.

The material according to the invention can detect the presence of gas by reversible variations in electrical properties; in particular, the minimum quantity of gas which it can detect is about three orders of magnitude less than with similar materials of the prior art.

Further characteristics and advantages of the materials and sensors according to the invention will become clear from the following description which relates to examples that are provided by way of non-limiting explanation.

### IN THE APPENDED DRAWINGS

FIGS. 1 and 2 are typical curves of the variation in resistance observed in sensors described in the examples given below, as a result of injections of different gases,

FIG. 3 is a comparison between two exposures of the EDDA sensor to successive injections of 1-butylamine, performed in different times, and

FIG. 4 is a typical curve of absorption and desorption of 1-butylamine in the sensor of FIG. 3.

### EXAMPLE 1

Synthesis of the Linear Polymer (BAC-DMEDA)

Bisacrylamidoacetic acid (BAC) (14.01 g, 70.05 mmol) was dissolved in 3M NaOH (23.35 ml) and cooled in an ice bath and N-N′dimethylethylene diamine (DMEDA) (6.52 g, 59.84 mmol) was added, with stirring. The solution was then diluted with water to give a 50% concentration of the sum of the monomers. The reaction mixture was subjected to successive vacuum and nitrogen cycles and left in a nitrogen atmosphere in the dark at 25° C. for 24 hours. The product was isolated by ultrafiltration in an Amicon cell with a YM3 membrane, followed by lyophilization.

### EXAMPLE 2

Synthesis of the Linear Polymer (BAC-EDDA)

Bisacrylamidoacetic acid (BAC) (5.3 g, 26.5 mmol) was dissolved in 3M NaOH (8.83 ml), a small quantity of 4-methoxyphenol was added, and the mixture was then cooled in an ice bath. The reaction mixture was subjected to successive vacuum and nitrogen cycles and triethylamine (TEA) (9.42 ml) and N-N′ethylenediaminodiacetic acid (EDDA) (3.97 g, 22.53 mmol.) were added with stirring. The solution was then diluted with water to give a 50% concentration of the sum of the monomers. The reaction mixture was subjected to successive vacuum and nitrogen cycles and left in a nitrogen atmosphere in the dark at 25° C. for 24 hours.

The reaction mixture was diluted to 250 ml with twice-distilled H₂O and then ultrafiltered in an AMICON cell with a YM3 membrane, after which its pH was brought to 3 by the addition of 1N HCl. Finally, the polymer was isolated by lyophilization.

### EXAMPLE 3

Preparation of the DMEDA Sensor

2 solutions A and B, as given below, were prepared.

Solution A

The polymer BAC-DMEDA (80 mg), prepared as described in Example 1, was dissolved in 10 ml of distilled water and the final pH of the solution was checked to confirm that it was between 7 and 8.

Solution B

Carbon black (20 mg) was suspended in 10 ml of water and Brij 30 (30 mg) was added.

After suspension B had been exposed to an ultrasound bath for 5 minutes, 1 ml of each of solutions A and B were drawn and were mixed and subjected to ultrasound again for a further 5 minutes. 1 ml of this solution was poured into a polyethylene container (d=18 mm, h=4 mm) in the base of which a lapped alumina substrate (dimensions 3×3×0.1 mm), provided with gold contacts and an interdigitated circuit for connection between the contacts, had previously been arranged. The container was placed in an atmosphere with forced ventilation at a temperature of 25° C. After about 10-12 hours, the solvent had completely evaporated and a continuous and homogeneous film, which covered the surface of the substrate, had been deposited.

### EXAMPLE 4

Preparation of the EDDA Sensor

This sensor was prepared by the same method and with the same ingredients as described in example 3, with the sole difference that, in the preparation of solution A, the BAC-EDDA polymer, prepared as described in example 2, replaced the BAC-DMEDA polymer.

### EXAMPLE 5

Preparation of the DMEDA Cu⁺⁺ Sensor

This sensor was prepared by the same method and with the same ingredients as described in example 3, with the sole difference that CuCl₂.2H₂O (30 mg) was added in the preparation of solution A.

### EXAMPLE 6

Preparation of the DMEDA Co⁺⁺ Sensor

This sensor was prepared by the same method and with the same ingredients as described in example 3, with the sole difference that CoCl₂.6H₂O (30 mg) was added in the preparation of solution A.

### EXAMPLE 7

Preparation of the EDDA Cu⁺⁺ Sensor

This sensor was prepared by the same method and with the same ingredients as described in example 4, with the sole difference that CuCl₂.2H₂O (30 mg) was added in the preparation of solution A.

### EXAMPLE 8

Preparation of the EDDA Co⁺⁺ Sensor

This sensor was prepared by the same method and with the same ingredients as described in example 4, with the sole difference that CoCl₂.6H₂O (30 mg) was added in the preparation of solution A.

### EXAMPLE 9

Gas Absorption

The sensors prepared as described in examples 3-8 were placed in a test chamber into which known quantities of gas were injected.

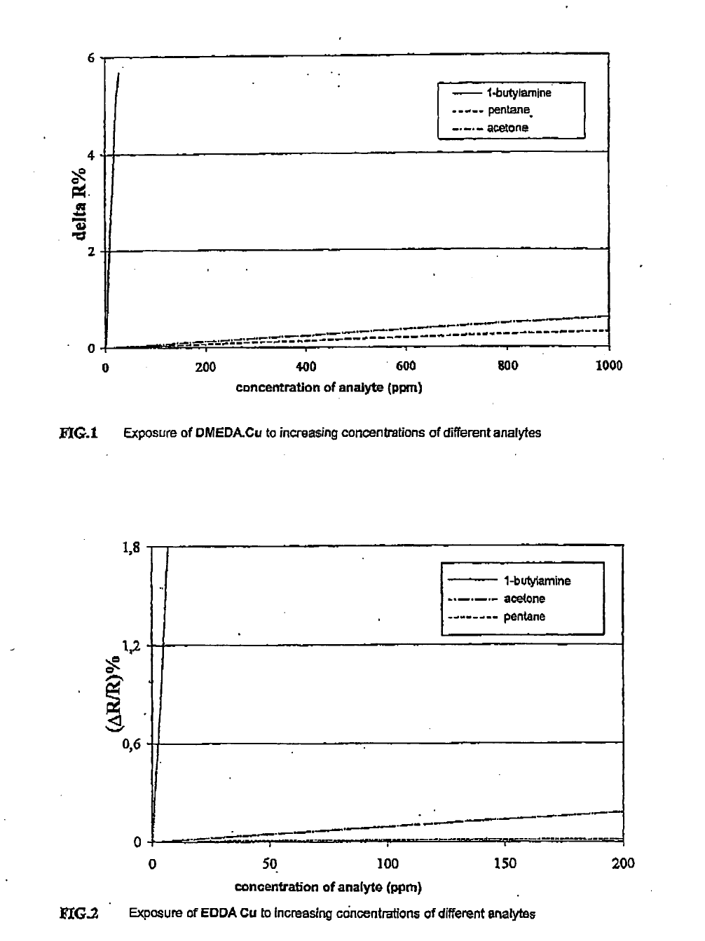

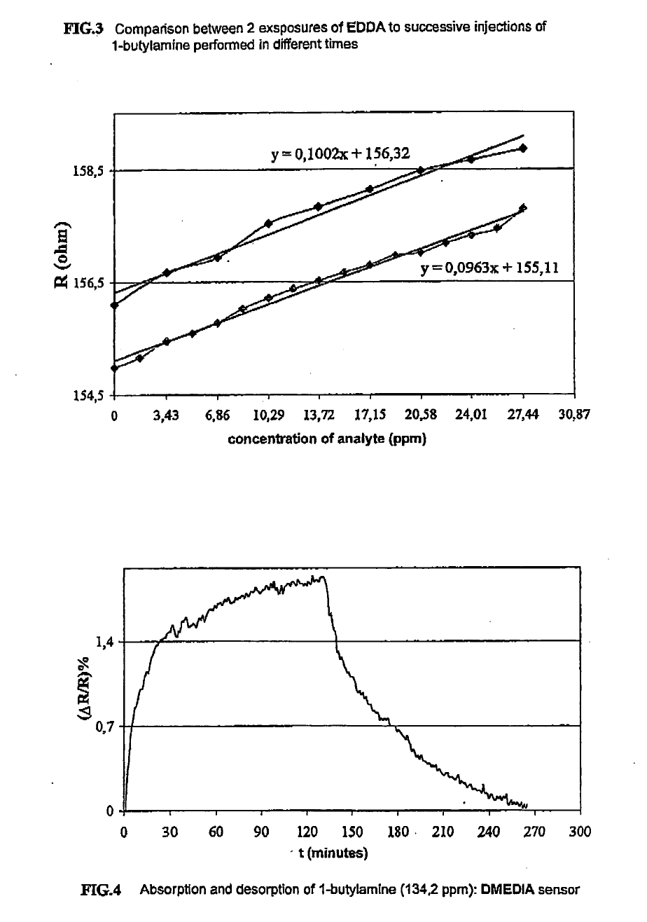

FIGS. 1 and 2 are curves of variation in resistance relating to the sensors of examples 5, 7 and 4, exposed to the gases indicated therein.

1. A film of composite material useful as a sensor for detecting an analyte in a fluid, comprising a matrix of a non-conductive polymer, in which a conductive filler is dispersed, characterized in that the non-conductive polymer comprises a polyamidoamine.

2. A film according to claim 1, characterized in that the polyamidoamine is the product of the addition of a primary monoamine or of secondary bisamine to bisacrylamide, optionally N,N substituted.

3. A film according to claim 1 which the polyamidoamine is a compound of formula (I): 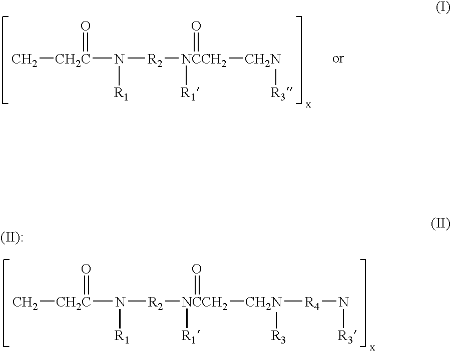
where R₁ and R₁′, independently of one another, may be a hydrogen or a linear or branched CnH2n+1 hydrocarbon chain where n=1-4,
R₂ may be CH—COOH or a linear or branched CₙH₂ₙ hydrocarbon chain where n=1-4,
R₃, R₃′ and R₃″, independently of one another, may be CH₂—COOH, CH₂—CH₂—OH, CH₂—CH₂—N(CH₃)₂ or a linear or branched CₙH₂ₙ₊₁ hydrocarbon chain where n=1-4,
R₄ may be a linear or branched CₙH₂ₙ hydrocarbon chain where n=2-4, and
X is a whole number between 1 and 100.

4. A film according to claim 3 in which the polyamidoamine is a compound of formula (II) in which both R₁ and R₁′ are hydrogen, R₂ is CH—COOH, and R₃, R₃′ are selected from CH₃ and CH₂COOH, and X is between 10 and 60.

5. A film according to claim 1 in which the conductive filler is constituted by a carbon black or by a metal powder.

6. A film according to claim 1, further comprising a non-ionic surfactant and/or a plasticizer.

7. A film according to claim 1 in which the polyamidoamine is complexed with metal ions.

8. A chemical sensor device comprising a first conductive element and a second conductive element connected by a resistive element defining an electrical path between the conductive elements, characterized in that the resistive element comprises a film of composite material according to claim 1.

9. A device according to claim 8, characterized in that the film of composite material is deposited on an insulating substrate.

10. A device according to claim 9, characterized in that the insulating substrate is selected from alumina, ceramic materials, and silicates.

11. Apparatus for detecting an analyte in a fluid, comprising a plurality of sensor devices according to claim 8, connected in a matrix configuration and combined with an electrical measuring apparatus.
